(19) United States
(12) Patent Application Publication
(10) Pub. No.: US 2018/0304581 A1
(43) Pub. Date: Oct. 25, 2018

(54) VENEER SHEET AND METHOD OF MANUFACTURING SAME

(71) Applicant: KABUSHIKI KAISHA TOKAI RIKA DENKI SEISAKUSHO, Aichi (JP)

(72) Inventor: Atsushi MAEDA, Aichi (JP)

(21) Appl. No.: 15/944,149

(22) Filed: Apr. 3, 2018

(30) Foreign Application Priority Data
Apr. 19, 2017 (JP) 2017-082849

(51) Int. Cl. B32B 7/12; B27D 1/00; B32B 5/02; B32B 21/14; B32B 27/34; B32B 33/00; C09J 5/06

(52) U.S. Cl. CPC B32B 7/12; B27D 1/00; B32B 5/022; B32B 21/14; B32B 2307/306; B32B 33/00; C09J 5/06; B32B 2255/08; B32B 2305/08; B32B 27/34

(57) ABSTRACT

A veneer sheet includes a veneer formed from a thin sheet of wood, a reinforcing material reinforcing the veneer, and an adhesive layer including the reinforcing material and a first adhesive layer and a second adhesive layer present on both sides of the reinforcing material, the first and second adhesive layers being layers of hot melt adhesive. The adhesive layer is integral with the veneer.

The present application is based on Japanese patent application No. 2017-082849 filed on Apr. 19, 2017, the entire contents of which are incorporated herein by reference.

### BACKGROUND

### Technical Field

The present invention relates to a veneer sheet and a method of manufacturing the same.

### Background Art

A veneer insert film comprising a base film and a veneer laminate is known in the art (see, for example, JP 2013/95125 A). The veneer laminate has a specific pattern, and is adhered to one side surface of the base film by a hot melt adhesive layer.

This veneer laminate is constituted by veneer, an adhesive layer, and a nonwoven fabric layered in this order.

### SUMMARY

The veneer of known veneer insert films may peel depending on the environment in a case where the adhesive used for the adhesive layer is aqueous and has low heat resistance. The veneer of known veneer insert films may also peel, in a case where the adhesive has low water resistance, as the result of water-absorbent treatments performed prior to coating or the like that prevent the veneer compressed in insert molding from recovering due to water.

Accordingly, an object of the present invention is to provide a veneer sheet capable of preventing peeling of veneer, and a method of manufacturing the same.

One aspect of the present invention provides a veneer sheet, comprising:
a veneer formed from a thin sheet of wood;
a reinforcing material reinforcing the veneer; and
an adhesive layer comprising the reinforcing material and a first adhesive layer and a second adhesive layer present on both sides of the reinforcing material, the first and second adhesive layers being layers of hot melt adhesive,
wherein the adhesive layer is integral with the veneer.

In accordance with the present invention, it is possible to prevent peeling of veneer.

### BRIEF DESCRIPTION OF THE DRAWINGS

FIG. 1 is a cross-sectional view of main parts of an example of a veneer-decorated article to which a veneer sheet according to a first embodiment is applied. FIGS. 2A and 2B are schematic views illustrating an example of a method of manufacturing the veneer sheet according to the first embodiment. FIG. 3 is a cross-sectional view of main parts of an example of a veneer-decorated article to which a veneer sheet according to a second embodiment is applied.

### DESCRIPTION OF EMBODIMENTS

### Summary of Embodiment

A veneer sheet according to one embodiment generally includes veneer formed from a thin sheet of wood, a reinforcing material reinforcing the veneer, an adhesive layer present on both sides of the reinforcing material, including a first adhesive layer and a second adhesive layer being layers of hot melt adhesive, and integral with the veneer.

The adhesive layer of the veneer sheet is formed using a hot melt adhesive, and thus have high heat resistance and water resistance, enabling prevention of peeling of the veneer compared to when an aqueous adhesive is used.

### First Embodiment

### Summary of Veneer Sheet 1

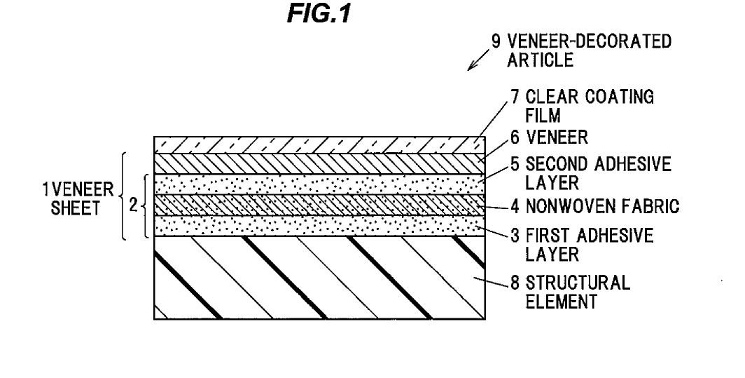

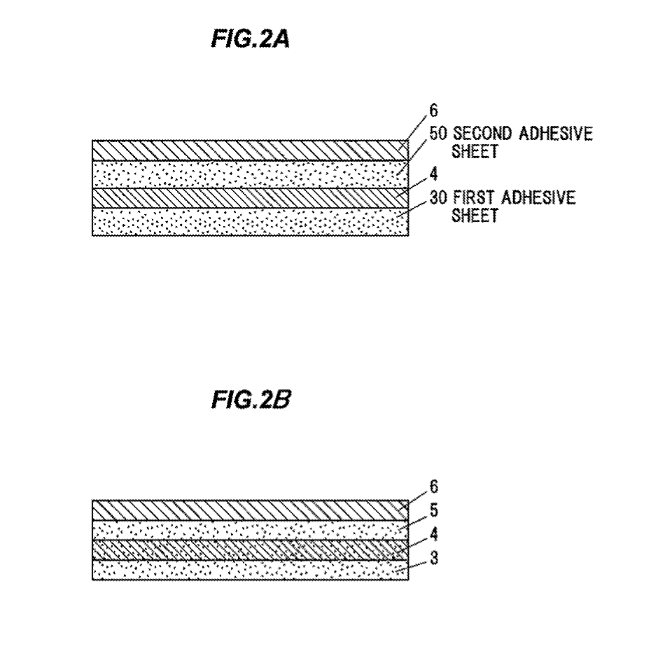

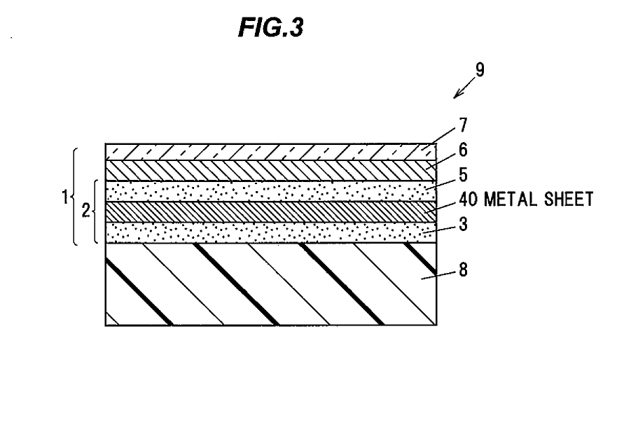

FIG. 1 is a cross-sectional view of main parts of one example of a veneer-decorated article to which a veneer sheet according to a first embodiment is applied. FIGS. 2A and 2B are schematic views illustrating one example of a method of manufacturing the veneer sheet according to the first embodiment. In the drawings associated with the following embodiments, the proportions of elements in the drawings may differ from their actual proportions. Numerical ranges expressed as “A to B” are used in the sense of at least A and not greater than B.

A veneer sheet 1 is a sheet used in forming a veneer-decorated article 9 that is integrated with a structural element 8, such as a resin article of a vehicle, and has an appearance like that of real wood, for example. Thus, the veneer sheet 1 is formed in a thin sheet shape so as to be easily integrated with curved surfaces.

As illustrated in FIG. 1, for example, the veneer sheet 1 generally includes veneer 6 formed from a thin sheet of wood, a reinforcing material reinforcing the veneer 6, and an adhesive layer 2 present on both sides of the reinforcing material, including a first adhesive layer 3 and a second adhesive layer 5 being layers of hot melt adhesive, and integral with the veneer 6. The reinforcing material of the present embodiment is a nonwoven fabric 4 impregnated with a hot melt adhesive. A clear coating film 7 is formed on a surface of the veneer 6.

### Configuration of Adhesive Layer 2

The adhesive layer 2 is formed from the first adhesive layer 3, the nonwoven fabric 4, and the second adhesive layer 5. As illustrated in FIG. 2A, for example, the adhesive layer 2 is formed by layering the veneer 6, a first adhesive sheet 30 obtained by forming a hot melt adhesive into a sheet, the nonwoven fabric 4 reinforcing the veneer 6, and a second adhesive sheet 50 obtained by forming a hot melt adhesive into a sheet, and performing thermal compression bonding.

The first adhesive sheet 30 and second adhesive sheet 50 forming the first adhesive layer 3 and second adhesive layer 5 is, for example, an olefin-based or nylon-based hot melt adhesive sheet or the like having high heat resistance and water resistance. The thickness of the first adhesive layer 3 and the second adhesive layer 5 is, for example, about 0.1 mm.

The nonwoven fabric 4 is, for example, a polyester or rayon-based nonwoven fabric or the like. The thickness of the nonwoven fabric 4 is, for example, about 0.2 mm.

### Configuration of Veneer 6

The veneer 6 is, for example, a thin sheet-shaped member of walnut, hard maple, bamboo, engineered wood, or the like. The thickness of the veneer 6 is, for example, about 0.2 mm.

### Configuration of Clear Coating Film 7

The clear coating film 7 is a coating film formed by applying a clear coating to the surface of the veneer 6 after the insert molding of the veneer-decorated article 9. Mirror finishing may be performed on the surface of the clear coating film 7. Additionally, the clear coating film 7 may be matte.

### Configuration of Structural Element 8

The structural element 8 is, for example, formed from a resin material such as nylon 6, nylon 66, or nylon 12. The structural element 8 is, for example, a resin panel in which an interior instrument, touch pad, or the like is disposed.

An example of a method of manufacturing the veneer sheet 1 according to the present embodiment will be described below.

### Method of Manufacturing Veneer Sheet 1

As illustrated in FIG. 2A, veneer 6 formed from a thin sheet of wood, the second adhesive sheet 50 obtained by forming a hot melt adhesive into a sheet, the nonwoven fabric 4 reinforcing the veneer 6, and the first adhesive sheet 30 obtained by forming a hot melt adhesive into a sheet are layered in this order.

Next, as illustrated in FIG. 2B, the veneer 6, the second adhesive sheet 50, the nonwoven fabric 4, and the first adhesive sheet 30 are layered and subjected to thermal compression bonding to form a veneer sheet 1 in which the nonwoven fabric 4 is impregnated with hot melt adhesive. The first adhesive sheet 30 and the second adhesive sheet 50 are melted by the thermal compression bonding and impregnate the nonwoven fabric 4. The remaining of the first adhesive sheet 30 becomes the first adhesive layer 3, and the remaining of the second adhesive sheet 50 becomes the second adhesive layer 5.

The veneer sheet 1 is then set in a mold into which molten resin is introduced to perform insert molding, and the molten resin hardens to form the structural element 8 that is integrated with the veneer sheet 1. A clear coating is then applied on the veneer 6, and mirror finishing and the like are also performed to obtain the veneer-decorated article 9 illustrated in FIG. 1.

### Effects of First Embodiment

The veneer sheet 1 according to the present embodiment is capable of preventing peeling of the veneer 6. Specifically, the veneer sheet 1 uses a hot melt adhesive, and thus has high heat resistance and water resistance, enabling prevention of peeling of the veneer 6 compared to when an aqueous adhesive is used.

The veneer sheet 1 is formed by sandwiching the nonwoven fabric 4 between the first adhesive sheet 30 and second adhesive sheet 50 including the hot melt adhesive, and performing thermal compression bonding along with the veneer 6. Therefore, the hot melt adhesive can more easily and sufficiently impregnate the nonwoven fabric 4 than in a case where the hot melt adhesive is only applied to one surface of the veneer, and can thus function better as a reinforcing material for the veneer 6. The first adhesive layer 3 of the veneer sheet 1 and the structural element 8 are integrated by the heat of the molten resin during insert molding even without the application of an extra adhesive, thus, the process can the simplified and costs can be reduced.

In manufacturing methods using a liquid adhesive, numerous aspects need to be monitored, such as the storage of the adhesive, the proportions and stirring state of the main agent and the curing agent, and pot life (usage time), and the state of the adhesive is affected by the environment in which it is used, making it difficult to ensure stable quality. However, the method of manufacturing the present veneer sheet 1 primarily requires monitoring of temperature, pressure, and time in the thermal compression bonding apparatus, and the environment in which the veneer sheet 1 is used has little effect on the veneer sheet 1, ensuring stable quality of the veneer sheet 1.

### Second Embodiment

A second embodiment differs from the first embodiment in that the reinforcing material is a metal sheet.

FIG. 3 is a cross-sectional view of main parts of an example of a veneer-decorated article to which a veneer sheet according to a second embodiment is applied. In the embodiment described below, parts having the same functions and configurations as in the first embodiment will be given the same reference numerals as in the first embodiment, and descriptions thereof will be omitted.

As illustrated in FIG. 3, for example, the veneer sheet 1 of the present embodiment generally includes veneer 6 formed from a thin sheet of wood, a metal sheet 40 as a reinforcing material reinforcing the veneer 6, and an adhesive layer 2 present on both sides of the metal sheet 40, including a first adhesive layer 3 and a second adhesive layer 5 being layers of hot melt adhesive, and integral with the veneer 6.

A metal having high bondability with hot melt adhesives, such as aluminum, is used for the metal sheet 40. The thickness of the metal sheet 40 is, for example, from 0.1 to 1.0 mm.

An example of a method of manufacturing the veneer sheet 1 according to the present embodiment will be described below.

### Method of Manufacturing Veneer Sheet 1

The veneer 6 formed from a thin sheet of wood, the second adhesive sheet 50 obtained by forming a hot melt adhesive into a sheet, the metal sheet 40 reinforcing the veneer 6, and the first adhesive sheet 30 obtained by forming a hot melt adhesive into a sheet are layered in this order.

Next, the veneer 6, the second adhesive sheet 50, the metal sheet 40, and the first adhesive sheet 30 are layered and subjected to thermal compression bonding to form a veneer sheet 1.

The veneer sheet 1 is then set in a mold into which molten resin is introduced to perform insert molding, and the molten resin hardens to form a structural element 8 that is integrated with the veneer sheet 1. A clear coating is then applied on the veneer 6, and mirror finishing and the like is performed to obtain the veneer-decorated article 9 illustrated in FIG. 3.

### Effects of Second Embodiment

The veneer sheet 1 according to the present embodiment uses a metal sheet 40 that has high bondability with the hot melt adhesive, allowing peeling of the veneer 6 to be prevented.

Although several embodiments of the present invention and a modified example thereof have been described above, these embodiments and modified example are merely examples, and the invention according to claims is not intended to be limited thereto. Such novel embodiments and a modified example can be implemented in various other forms, and various omissions, substitutions, changes, and the like can be made without departing from the spirit and scope of the present invention. In addition, all combinations of the features described in these embodiments and modified example are not necessary to solve the problem. Furthermore, these embodiments and modified examples are included within the spirit and scope of the invention and also within the invention described in the claims and the scope of equivalents thereof.

### REFERENCE SIGNS LIST

1 Veneer sheet
2 Adhesive layer
3 First adhesive layer
4 Nonwoven fabric
5 Second adhesive layer
6 Veneer
7 Clear coating film
8 Structural element
9 Veneer-decorated article
30 First adhesive sheet
40 Metal sheet
50 Second adhesive sheet

1. A veneer sheet, comprising:
a veneer formed from a thin sheet of wood;
a reinforcing material reinforcing the veneer; and
an adhesive layer comprising the reinforcing material and a first adhesive layer and a second adhesive layer present on both sides of the reinforcing material, the first and second adhesive layers being layers of hot melt adhesive,
wherein the adhesive layer is integral with the veneer.

2. The veneer sheet according to claim 1, wherein the reinforcing material comprises a nonwoven fabric impregnated with the hot melt adhesive.

3. The veneer sheet according to claim 1, wherein the reinforcing material comprises a metal sheet.

4. A method of manufacturing a veneer sheet, comprising:
forming a stack by layering a veneer formed from a thin sheet of wood, a second adhesive sheet as a sheet-shaped hot melt adhesive, a nonwoven fabric reinforcing the veneer, and a first adhesive sheet as a sheet-shaped hot melt adhesive in this order; and
performing thermal compression bonding on the stack to form a veneer sheet in which the nonwoven fabric is impregnated with the hot melt adhesive.

5. The veneer sheet according to claim 1, wherein the reinforcing material comprises a nonwoven fabric impregnated with a part of each of the hot melt adhesives of the first and second adhesive layers.

6. The veneer sheet according to claim 1, wherein the hot melt adhesive comprises one of olefin-based and nylon-based hot melt adhesives having a heat resistance and a water resistance.
